(19) United States
(12) Patent Application Publication
(10) Pub. No.: US 2025/0315576 A1
(43) Pub. Date: Oct. 9, 2025

(54) METHOD, ELECTRONIC DEVICE, AND COMPUTER PROGRAM PRODUCT FOR DETERMINING PREDICTION RESULT

(71) Applicant: Dell Products L.P., Round Rock, TX (US)

(72) Inventors: Qiang Chen, Shanghai (CN); Pedro Fernandez Orellana, Surfers Paradise (AU)

(21) Appl. No.: 18/652,933

(22) Filed: May 2, 2024

(30) Foreign Application Priority Data
Apr. 9, 2024 (CN) 202410423842.1

(51) Int. Cl. G06F 30/27; G06F 30/23

(52) U.S. Cl. CPC G06F 30/27; G06F 30/23

(57) ABSTRACT

Embodiments of the present disclosure provide a method, an electronic device, and a computer program product for determining a prediction result. The method includes acquiring a first operating condition data set and outputting a first output result corresponding to the first operating condition data set through a machine learning model. The machine learning model is obtained by training on a second operating condition data set and a second prediction result, and the second prediction result is obtained by simulating on the second operating condition data set. The method further includes determining a corresponding first prediction result by simulating on the first operating condition data set based on the first output result. In this way, a result predicted by the machine learning model can be used as a reference for simulating on operating condition data, thereby improving the accuracy and efficiency of the simulation.

### RELATED APPLICATION

The present application claims priority to Chinese Patent Application No. 202410423842.1, filed Apr. 9, 2024, and entitled “Method, Electronic Device, and Computer Program Product for Determining Prediction Result,” which is incorporated by reference herein in its entirety.

### FIELD

Embodiments of the present disclosure relate to the field of model processing, and in particular, to a method, an electronic device, and a computer program product for determining a prediction result.

### BACKGROUND

A simulation algorithm is an algorithm that solves a problem by simulating an actual physical, mathematical, or logical process. For example, the simulation algorithm can be based on solving a control equation of fluid mechanics through computer and numerical methods to simulate and analyze a fluid mechanics problem. Due to its advantages of fast simulation speed and high simulation accuracy, the simulation algorithm plays a crucial role in the design and optimization of a network device. Through simulation, a user (such as an engineer) can predict and evaluate the performance and reliability of a network device under different operating conditions without an actual physical model. In this way, the user can discover and correct a potential problem during a simulation phase, thereby greatly reducing development time and costs.

### SUMMARY

Embodiments of the present disclosure involve a method, an electronic device, and a computer program product for determining a prediction result.

According to a first aspect of the present disclosure, a method for determining a prediction result is provided. The method includes acquiring a first operating condition data set and outputting a first output result corresponding to the first operating condition data set through a machine learning model. The machine learning model is obtained by training on a second operating condition data set and a second prediction result, and the second prediction result is obtained by simulating on the second operating condition data set. The method further includes determining a corresponding first prediction result by simulating on the first operating condition data set based on the first output result.

According to a second aspect of the present disclosure, an electronic device for determining a prediction result is provided. The electronic device includes at least one processor and a memory, coupled to the at least one processor and having instructions stored therein, wherein the instructions, when executed by the at least one processor, cause the electronic device to perform actions. The actions include acquiring a first operating condition data set, and outputting a first output result corresponding to the first operating condition data set through a machine learning model, wherein the machine learning model is obtained by training on a second operating condition data set and a second prediction result, and the second prediction result is obtained by simulating on the second operating condition data set. The actions further include determining a corresponding first prediction result by simulating on the first operating condition data set based on the first output result.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform the method implemented in the first aspect of the present disclosure. The method includes acquiring a first operating condition data set; outputting a first output result corresponding to the first operating condition data set through a machine learning model, wherein the machine learning model is obtained by training on a second operating condition data set and a second prediction result, and the second prediction result is obtained by simulating on the second operating condition data set; and determining a corresponding first prediction result by simulating on the first operating condition data set based on the first output result.

### BRIEF DESCRIPTION OF THE DRAWINGS

By the following Detailed Description of example embodiments of the present disclosure, provided herein with reference to the accompanying drawings, the above and other objectives, features, and advantages of the present disclosure will become more apparent, wherein identical reference numerals generally represent identical element in the example embodiments of the present disclosure, and in which:

FIG. 1 is a schematic diagram of an example environment in which a device and/or a method according to embodiments of the present disclosure can be implemented;

FIG. 2 is a schematic diagram of simulating on a third operating condition data set and retraining a machine learning model according to an embodiment of the present disclosure;

FIG. 3 is a flow chart of a method for determining a prediction result according to an embodiment of the present disclosure;

FIG. 4 is a schematic diagram of a structure of a machine learning model according to some embodiments of the present disclosure;

FIG. 5 is a schematic diagram of performing progressive fitting on operating condition data according to some embodiments of the present disclosure;

FIG. 6 is a schematic diagram of a validity experiment result according to some embodiments of the present disclosure; and

FIG. 7 is a block diagram of an example device that can be used to implement embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As mentioned above, a simulation algorithm can solve complex fluid flow problems through numerical calculation methods based on the basic principles and equations of fluid mechanics. For example, established mathematical, physical, or logical models are transformed into discrete forms that can be processed by computers, and computational power is utilized for solving and analysis, so as to obtain simulation results that can be used to describe a temperature field, a pressure field, or a density field. However, the established models are often highly complex and often discretized into large-scale grids with millions or even billions of cells. This means that simulation requires High Performance Computing (HPC) clusters for execution. These clusters may contain hundreds or even thousands of processor cores, as well as a significant amount of memory and storage. Therefore, how to reduce the cost and time of simulation is a challenge to improve the simulation speed and save simulation resources.

Therefore, embodiments of the present disclosure provide a method for determining a prediction result. The method includes acquiring a first operating condition data set and outputting a first output result corresponding to the first operating condition data set through a machine learning model. The machine learning model is obtained by training on a second operating condition data set and a second prediction result, and the second prediction result is obtained by simulating on the second operating condition data set. The method further includes determining a corresponding first prediction result by simulating on the first operating condition data set based on the first output result. In this way, the machine learning model can be integrated into the simulation process, and the machine learning model can be constructed based on data from a completed simulation. A result of the next set of operating condition data predicted by the machine learning model can be used as a reference for the simulation on the next set of operating condition data, thereby providing an approximate estimation result for the simulation process and further improving the accuracy and efficiency of the simulation. In addition, the machine learning model typically requires less computation than a complete simulation model, and therefore, computational requirements may be greatly reduced, thereby saving computation time and resources.

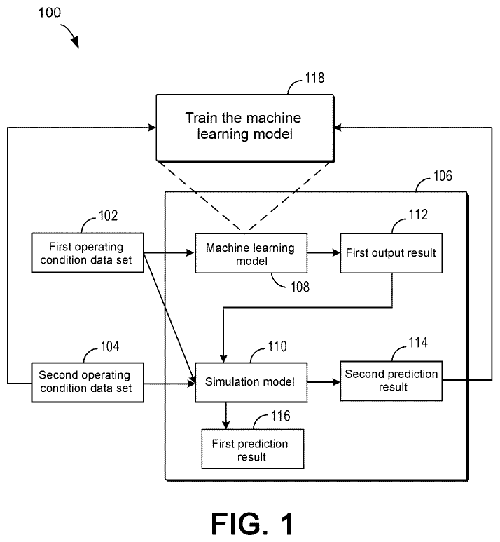

Basic principles and several examples of the present disclosure will be described in detail below with reference to the accompanying drawings. FIG. 1 is a schematic diagram of an example environment 100 in which a device and/or a method according to embodiments of the present disclosure can be implemented. It should be understood that the number and arrangement of components, elements, and models illustrated in FIG. 1 are examples only, and different numbers and arrangements of components, elements, and models may be included in the example environment 100. As shown in FIG. 1, the example environment 100 includes a computing device 106. A machine learning model 108 and a simulation model 110 are installed on the computing device 106. It should be understood that the above examples are only intended to illustrate the application of the machine learning model 108 and the simulation model 110. In other embodiments, as technologies continue to develop, a combination of the machine learning model 108 and the simulation model 110 may be included in a variety of known or unknown applications in various fields and aspects.

In the example environment 100, the computing device 106 may be a device that has processing computing resources or storage resources. For example, the computing device 106 may have common capabilities such as receiving and sending data requests, real-time data analysis, local data storage, and real-time network connection. The computing device 106 may typically include various types of devices. Examples of the computing device 106 may include, but are not limited to, a desktop computer, a laptop, a smartphone, a wearable device, a security device, an intelligent manufacturing device, a smart home device, an IoT device, a smart car, a drone, and the like. In other embodiments of the present disclosure, the computing device 106 may also be a service terminal with computing power. The service terminal may be servers provided by various service providers, large scale computing devices, and the like, which is not limited in the present disclosure.

According to some embodiments disclosed herein, a first operating condition data set 102 may be input to the machine learning model 108, and after processing, the machine learning model 108 outputs a corresponding first output result 112. In order to enable the machine learning model 108 to accurately output the corresponding result, it is necessary to train 118 the machine learning model 108 by utilizing a second operating condition data set 104 and a corresponding second prediction result 114. The training method may be supervised training. This means that the machine learning model 108 may adjust its parameters based on the known output result (that is, the second prediction result 114) to optimize its performance. The second prediction result 114 may be obtained by simulating on the second operating condition data set 104 by using a conventional simulation method (such as using a conventional simulation model). For example, computational fluid dynamics (CFD) simulation may be used to simulate on the second operating condition data set 104, thereby obtaining a second prediction result 114. The CFD simulation is a simulation technique that uses a computer to solve various conservative control partial differential equations that describe fluid flow, heat transfer, and mass transfer, and performs visualized simulation on various solved flow or heat transfer phenomena.

According to some embodiments of the present disclosure, after the first output result 112 is determined, the first output result 112 may be input into the simulation model 110, and the simulation model 110 outputs a more accurate first prediction result 116 according to the first output result 112 and the first operating condition data set 102. It is to be understood that the first prediction result 116 includes temperature field data of the simulated device or system under the operating condition data.

In this way, the machine learning model can be integrated into the simulation process, and the machine learning model can be constructed based on data from a completed simulation. A result of the next set of operating condition data predicted by the machine learning model can be used as a reference for the simulation on the next set of operating condition data, thereby providing an approximate estimation result for the simulation process and further improving the accuracy and efficiency of the simulation. In addition, the machine learning model typically requires less computation than a complete simulation model, and therefore, computational requirements may be greatly reduced, thereby saving computation time and resources.

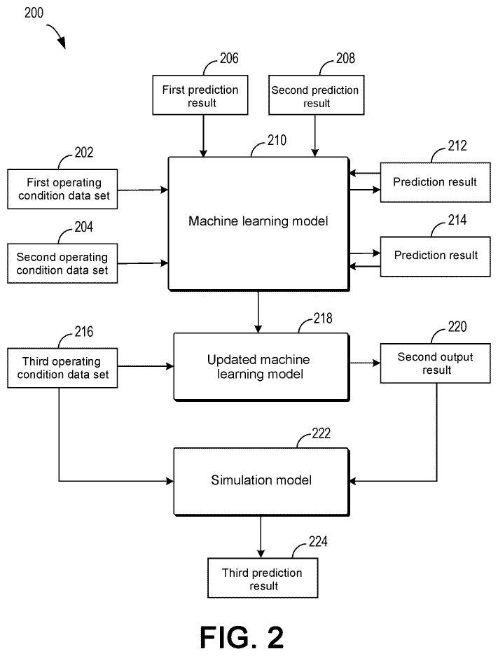

FIG. 2 is a schematic diagram 200 of simulating on a third operating condition data set and retraining a machine learning model 210 according to some embodiments of the present disclosure. As shown in FIG. 2, in order to obtain a more accurate prediction result, the learning and prediction capabilities of the machine learning model 210 may be further optimized. For example, the machine learning model 210 may be retrained using a first operating condition data set 202, a second operating condition data set 204, a first prediction result 206, and a second prediction result 208. The first prediction result 206 may be obtained by simulation through the method for determining a prediction result in the above embodiment. The second prediction result 208 may be obtained by simulating on the second operating condition data set 204 using the conventional simulation method. In other embodiments of the present disclosure, in order to improve the accuracy of the machine learning model training, the second prediction result 208 may also be obtained by simulating on the second operating condition data set 204 using the method for determining a prediction result in the above embodiment.

According to some embodiments of the present disclosure, the first operating condition data set 202 and the second operating condition data set 204 may be sequentially input into the machine learning model 210, and a corresponding prediction result 212 and a corresponding prediction result 214 may be output respectively by the machine learning model 210 after processing. The machine learning model 210 may be retrained according to a difference between the prediction result 212 and the first prediction result 206, as well as a difference between the prediction result 214 and the second prediction result 208, thereby obtaining an updated machine learning model 218. In this way, the machine learning model 210 may be continuously updated in an iterative manner, so that the learning and prediction abilities of the updated machine learning model are better, thereby making the finally determined prediction results more accurate.

It is to be understood that after obtaining the updated machine learning model 218, the third operating condition data set 216 may be input into the updated machine learning model 218, and a second output result 220 may be predicted by the updated machine learning model 218. The predicted second output result 220 is output to the simulation model 222, which is used as an initial condition by the simulation model 222 to simulate on the third operating condition data set 216 using a simulation algorithm, thereby obtaining a corresponding third prediction result 224.

It should be understood that after the third prediction result 224 is obtained, the training data may be reconstructed by using the first operating condition data set 202, the second operating condition data set 204, the third operating condition data set 216, the first prediction result 206, the second prediction result 208, and the third prediction result 224 to retrain the machine learning model, thereby obtaining a machine learning model with higher prediction accuracy. It is to be understood that when the machine learning model has higher prediction accuracy, more accurate prediction results are obtained and the simulation time is shorter.

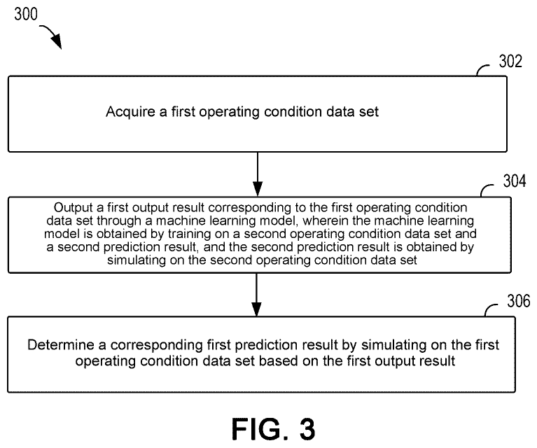

A flow chart of a method 300 for determining a prediction result according to an embodiment of the present disclosure will be described below with reference to FIG. 3. The method 300 for determining a prediction result according to an embodiment of the present disclosure may be performed at an edge device with computing power (for example, the computing device 106 shown in FIG. 1) or performed at a cloud server, which is not limited in the present disclosure. In order to improve the efficiency and accuracy of determining a prediction result, the method 300 for determining a prediction result according to an embodiment of the present disclosure is provided.

At a block 302, a first operating condition data set is acquired. The operating condition data set refers to a set of operating condition data collected in a specific working environment. The operating condition data describes various parameters and states of a device, system, or machine during operation. The operating condition data set may include data collected by various sensors and measuring devices. For example, the operating condition data may be operating condition data of a chassis of the server. In some examples, the operating condition data may be the input voltage and the output voltage of the chassis, the speed of a chassis fan, a central processing unit (CPU) fan, and the like, a disk usage, and the like. The data may be used to analyze the temperature distribution of the chassis of the server, thereby providing data support for improving the operational status and performance optimization of the chassis of the server. At a block 304, a machine learning model outputs a first output result corresponding to the first operating condition data set. The machine learning model is obtained by training on a second operating condition data set and a second prediction result, and the second prediction result is obtained by simulating on the second operating condition data set. The second operating condition data set and the first operating condition data set may be data sets obtained by sampling a determined operating condition data set. For example, in some examples, the operating condition data set includes operating condition data A, operating condition data B, operating condition data C, operating condition data D, operating condition data E, operating condition data F, and operating condition data G. After sampling, the first operating condition data set may be a set composed of the operating condition data C, the operating condition data D, and the operating condition data E. The second operating condition data set may be a set of the operating condition data A and the operating condition data F.

It should be understood that in order to optimize the simulation efficiency and simulation accuracy of the prediction result, the machine learning model may be combined with simulation, and the result output by the machine learning model may be used as a reference and auxiliary basis during the simulation process. In some embodiments, for example, the output of the machine learning model may provide a rough range of the prediction result for the simulation process, thereby improving the simulation speed. In order for the machine learning model to output a corresponding result based on the operating condition data set, it is necessary to train the machine learning model. For example, the machine learning model may be trained using the second operating condition data set and the second prediction result. The second prediction result is obtained by simulating on the second operating condition data set. For example, in accordance with the basic theories and numerical methods of CFD simulation, the fluid flow and heat transfer process inside a device (such as the chassis of the server) may be simulated and analyzed to determine the temperature field distribution inside the device (such as the chassis of the server). In other words, the second prediction result may be the simulated temperature field distribution of the chassis of the server under various operating condition data conditions in the second operating condition data set.

In some embodiments of the present disclosure, in the process of training the machine learning model, the second operating condition data from the second operating condition data set may be input into the machine learning model, and processed by the machine learning model to output a result. Network parameters of the machine learning model are adjusted iteratively according to a difference between the result and the second prediction result until the difference meets a requirement (such as the difference is less than a preset difference threshold). In this way, the machine learning model obtained after training can accurately output the temperature field distribution result of the chassis of the server under various types of operating condition data. The first operating condition data set is input into the machine learning model obtained by training, and the machine learning model outputs a corresponding first output result.

At a block 306, based on the first output result, a corresponding first prediction result is determined by simulating on the first operating condition data set. For example, the output result may be used as an initial state of the simulation. In some embodiments, a corresponding simulation model may be established according to actual physical characteristics and a heat transfer mechanism of a device (such as the chassis of the server). The simulation model may be a numerical model based on physical principles, such as a CFD model or another applicable simulation tool. By using a numerical method (such as a finite volume method, a finite difference method, and a finite element method) to solve the simulation model, the corresponding first prediction result is obtained. For example, the first prediction result may be a numerical solution of the fluid flow and heat transfer process inside the chassis of the server under the operating condition of the first operating condition data, that is, the temperature field distribution of the chassis of the server.

Through this method, the machine learning model can be used to obtain an approximate result corresponding to operating condition data. In this way, during simulation, only refinement of the approximate result is needed to obtain an accurate and physically feasible prediction result. In this way, compared with the method of directly simulating on operating condition data to obtain a prediction result, the solution for determining a prediction result provided in embodiments of the present disclosure can improve the accuracy of prediction results while reducing simulation time, thereby saving processing resources and costs.

It should be understood that the accuracy of the prediction result depends on the predictive ability of the machine learning model and the accuracy of the simulation model. The machine learning model needs to be fully trained and validated, such as training by using a large amount of historical operating condition data and corresponding temperature field data, so that the machine learning model obtained by training provides a reliable output result on new and unprecedented operating condition data. Based on this, after the second prediction result is obtained, the machine learning model may be retrained by using the second operating condition data set and the second prediction result, as well as the previous first operating condition data set and first prediction result, as training data. In this way, the retrained machine learning model performs better and can output a more accurate output result, thereby providing an accurate data reference for determination of a subsequent prediction result.

In some embodiments of the present disclosure, the machine learning model obtained by retraining may be used to output a corresponding second output result for a third operating condition data set, and provide an accurate initial condition for the simulation process for the third operating condition data set, thereby being capable of quickly obtaining a more accurate third prediction result. With the continuous increase of training data, the machine learning model may be continuously improved and produce a better estimation result for the new simulation process, thereby reducing subsequent simulation time. It is to be understood that the simulation time can be continuously decreased with the continuous improvement of the model.

In embodiments of the present disclosure, a machine learning model refers to a model that learns and extracts knowledge or patterns from training data through a machine learning algorithm, and then uses the knowledge for prediction or decision-making. The machine learning model may be classified into various types, such as a supervised learning model, an unsupervised learning model, a semi-supervised learning model, a reinforcement learning model, and the like. In some embodiments of the present disclosure, after the second operating condition data set and the corresponding second prediction result are acquired, an initial machine learning model may be constructed with training parameters set in the initial machine learning model. Then, various pieces of operating condition data from the second operating condition data set may be input into the initial machine learning model respectively to generate a result. The result may include temperature field data of the corresponding chassis of the server under different operating condition data. The training parameters are adjusted iteratively based on a difference between the result and the second prediction result until the difference meets a preset requirement. For example, if the number of iterations is greater than a predetermined number of times, the iterative adjustment is stopped and the current adjusted machine learning model is regarded as a machine learning model that finally meets the requirement.

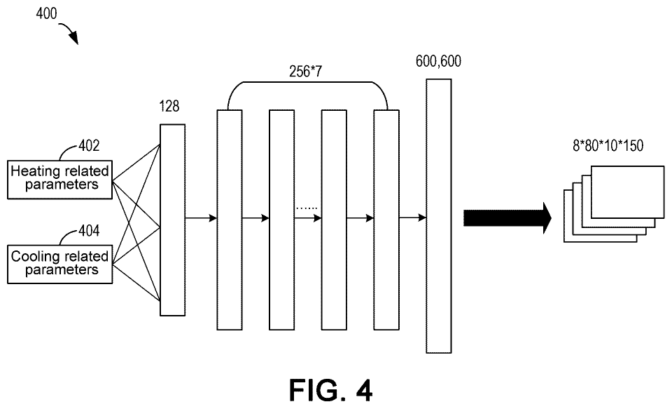

In some embodiments of the present disclosure, the structure of a machine learning model is illustrated by using the machine learning model being a multi-layer perceptron (MLP) model as an example. FIG. 4 is a schematic diagram 400 of a structure of a machine learning model according to some embodiments of the present disclosure. As shown in FIG. 4, the machine learning model may be a neural network model that uses an MLP for prediction. The machine learning model comprises an input layer, multiple hidden layers, and an output layer. Each layer in its structure includes a plurality of neurons, and at least a subset of the layers may be fully connected.

In some embodiments of the present disclosure, the MLP uses a hyperbolic tangent (tanh) function as an activation function, and its input size corresponds to the number of free parameter variables, while an output is related to the number of prediction units and the number of predicted physical quantities. As shown in FIG. 4, there are 8 input parameter variables of the machine learning model (such as pressure, temperature, three velocity components, enthalpy, turbulent kinetic energy, and specific dissipation rate), which may be classified into heating related parameters 402 and cooling related parameters 404. The heating related parameters 402 and the cooling related parameters 404 may be input to the input layer, and the number of neurons included in the input layer may be 128. The input layer may extract features of the heating related parameters 402 and the cooling related parameters 404, and transfer the extracted features to the hidden layers. The hidden layers are a key part of the machine learning model, mainly responsible for learning complex representations of the input features. The hidden layers transform the input features through a nonlinear activation function to capture nonlinear patterns in the input features.

As shown in FIG. 4, the machine learning model may include 7 hidden layers, and each hidden layer includes 256 neurons. Each hidden layer may learn different feature representations. The output layer is the final layer of the neural network, responsible for generating a final output of the network. The number of neurons in the output layer is usually related to the type of a task. For example, in an image classification task, the number of neurons in the output layer may be equal to the number of categories. The learned feature representations may be input into the output layer, and the output layer outputs the final prediction result. It is to be understood that after the prediction result is obtained, the prediction result may be reshaped to obtain the final output result. For example, the size of the output result may be 8*80*10*150. 8 refers to the number of input variables, and 80*10*150 refers to the size of a sampling grid. It should be understood that the network structure of the machine learning model is bounded, and the size of the network structure is related to the sampling size.

In some embodiments of the present disclosure, there are many types of parameters that affect the temperature of the chassis of the server, which may generally be classified into two types: heating related parameters and cooling related parameters. The heating related parameters refer to parameters that increase the temperature of the chassis of the server, such as a load status (such as memory usage and disk usage) of the chassis of the server and the power of the processor (such as the power of the CPU). The cooling related parameters refer to parameters that reduce the temperature of the chassis of the server, such as a working status (such as the speed of a chassis fan and the speed of a CPU fan) of a cooling system of the chassis of the server. In other embodiments of the present disclosure, the operating condition data may further include a temperature status of the chassis of the server (such as the internal temperature of the chassis, the CPU temperature, and the hard disk temperature), and the data can reflect the heat dissipation performance of the chassis of the server and the operating status of a hardware device.

In some embodiments of the present disclosure, due to the variety and large number of types of the operating condition data, for example, the operating condition data set may include the speed of the fan, the power of the CPU, the usage rate of the memory, and the like, in order to improve the simulation efficiency, the operating condition data may be sampled and simulation may be performed on the sampled operating condition data. For example, in an example, the power of the CPU may be sampled at a power of 10 W to 100 W, and the speed of the fan may be sampled at 10% to 100%. The operating condition data set obtained by sampling includes 100 pieces of operating condition data (for example, one piece of operating condition data is that the power of the CPU is 10 W and the speed of the fan is 50%).

It is to be understood that the operating condition data targeted by the machine learning model is the operating condition data obtained after sampling. If the output result of the machine learning model is subsequently used as the initial condition for the simulation process (such as an initial condition for a finite element model), it is necessary to upsample the output result to make the output result more in line with the actual prediction result. For example, interpolation may be used to upsample the output result back to an original grid from a coarse grid. The interpolation method may include nearest neighbor interpolation, bilinear interpolation, bicubic interpolation bases, and other methods. After the output result is upsampled, a corresponding result may be obtained for each parameter variable (operating condition data) on the original grid.

In some embodiments of the present disclosure, the simulation on the operating condition data is generally completed using a CFD solver. An output result serves as a reference condition for the CFD solver, and therefore, an input result may be imported into the CFD solver in an effective manner. It is to be understood that the import method depends on CFD software that is used. For example, in the field of electronic device and IT device design, the CFD software has a plurality of types of software. Different software may provide various methods of loading an external state, such as loading CFD General Notation System (CGNS) formats or other vendor independent formats, loading proprietary.dat.h5 formats, or using a UDF (user-defined function, which is a built-in C/C++ programming interface). In some embodiments of the present disclosure, different loading methods may be selected according to the actual CFD software and import requirements to import the output result into the CFD solver. The CFD solver outputs a corresponding prediction result based on the output result.

In some embodiments of the present disclosure, a finite element model may be established according to the physical structure and properties of the chassis of the server (such as geometric dimensions, material properties, specifications and configurations of heat dissipation components (such as fans and heat sinks), and other detailed information). According to the output result (predicted temperature field) of the machine learning model, a boundary condition and an initial condition for the finite element model are set. For example, the predicted temperature distribution may be used as an initial temperature condition for a heat dissipation component. In some embodiments of the present disclosure, the finite element model may also be meshed. For example, a geometric decomposition method may be used to mesh the finite element model, and the mesh generation function built-in in various types of simulation software may be used to mesh the finite element model. Afterwards, finite element analysis is performed on the finite element model to determine the heat transfer process of the finite element model in the chassis under the operating condition data condition. According to the finite element analysis result, the temperature field information in the chassis under the operating condition data condition may be determined.

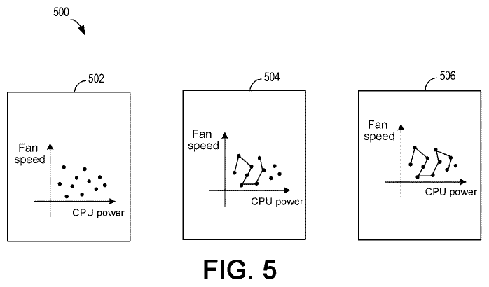

In some embodiments of the present disclosure, progressive fitting may be used to determine prediction results corresponding to a plurality of pieces of operating condition data. FIG. 5 is a schematic diagram 500 of performing progressive fitting on operating condition data according to some embodiments of the present disclosure. As shown in FIG. 5, the operating condition data may include the fan speed and the CPU power. A machine learning model is gradually constructed based on data from a completed simulation. For example, an operating condition data set 502 may contain a large number of pieces of operating condition data. The machine learning model is trained by using a part of operating condition data 504 that has undergone a simulation in the operating condition data set 502 to obtain the trained machine learning model.

In some embodiments of the present disclosure, the trained machine learning model may assist in simulating on the other part of operating condition data 506 to obtain a corresponding prediction result. Afterwards, the machine learning model may be retrained according to the other part of operating condition data 506. In other words, model parameters may be gradually adjusted for different operating condition data. For example, the model may be adjusted by adding new operating condition data, modifying the model structure, adjusting the weight, and other methods. After each adjustment, the model may be re-fitted and its prediction result may be evaluated under the operating condition data. In such a manner, the model may be gradually improved instead of trying to construct a perfect model from the beginning. In this way, it may be applied to situations where the operating condition data is complex and variable, the volume is large, and it is difficult to process at once.

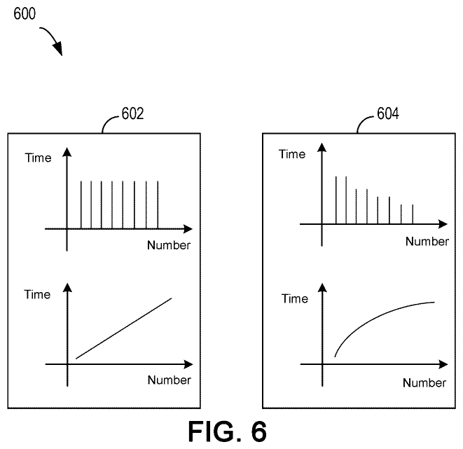

In some embodiments of the present disclosure, the validity of the method for determining a prediction result provided in embodiments of the present disclosure may be determined through experimental testing. FIG. 6 is a schematic diagram 600 of a validity experiment result according to an embodiment of the present disclosure. As shown in FIG. 6, a conventional simulation method 602 has basically the same simulation time for various pieces of operating condition data. As increasingly more pieces of operating condition data are simulated, the simulation time is also gradually accumulated. If there is a large amount of operating condition data, the simulation time may be very long (for example, it needs to take one month to obtain prediction results corresponding to all operating condition data). The method 604 according to some embodiments of the present disclosure can gradually shorten the simulation time of operating condition data. For example, with the continuous optimization of the machine learning model, the simulation time is also continuously shortened, and the cumulative speed of the simulation time may become increasingly slower. As can be seen, through the method according to some embodiments of the present disclosure, the simulation time and simulation resources can be saved, and the prediction efficiency of the prediction result can be improved.

In some embodiments of the present disclosure, the feasibility and validity of the solution for determining a prediction result provided in embodiments of the present disclosure may be experimentally tested. For example, predicting a temperature field of a chassis of a server with 2.5 million cells may be taken as an example. Simulation including 1000 pieces of operating condition data is performed in a parameter space including 6 parameter variables. The 6 parameter variables may include 4 heating related parameters and 2 cooling related parameters. In a testing experiment, there are different degrees of noise effects in prediction results.

The experimental results are shown in the following Table 1. As can be seen from the experimental results, even in the presence of a 6% prediction error, the method provided in an embodiment of the present disclosure can complete the simulation within 30 iterations. In contrast, traditional methods typically require about 100 iterations. The experimental results indicate that the method provided by the embodiment of the present disclosure has significant advantages in efficiency and accuracy, thereby being capable of providing a new approach for simulating and optimizing the chassis of the server.

TABLE 1
Number of simulation iterations under different scenarios

| Error | Number of iterations |
|---|---|
| Use standard simulation | 131 |
| software initialization | |
| Use a traditional | 89 |
| simulation method | |
| 6% | 30 |
| 3% | 26 |
| 1% | 22 |
| 0.1% | 14 |
| 0% | 1 |

In some embodiments, the convergence performance and simulation time of the models included in the method implemented according to an embodiment of the present disclosure may also be evaluated based on the experimental results. Table 2 shows comparison results of the method with several other reference methods. The experimental results indicate that if the selected condition happens to be very close to the current condition (Method C), it may converge quickly. However, there are still significant variations and randomness in the results. On the other hand, performing simulation based on the output results of the machine learning model according to embodiments of the present disclosure can stably reduce simulation time. Compared with Fluent standard initialization, the method provided in embodiments of the present disclosure may reduce the simulation time by 63.5%, and compared with the simulation time in other methods, the simulation time is reduced by 20.2% on average.

TABLE 2
Number of simulation iterations corresponding
to using different simulation methods

| Method | Number of iterations |
|---|---|
| Use standard Fluent | 137 |
| initialization | |
| Use Method A | 68 |
| Use Method B | 83 |
| Use Method C | 37 |
| Method of the present | 50 |
| disclosure | |
| Initial parameter | 1 |

In some embodiments of the present disclosure, the design, heat dissipation strategy, or operating condition of the chassis of the server may be optimized according to a prediction result obtained by simulation. Then, the optimized data is used to retrain the machine learning model to improve its prediction accuracy, and the above process is repeated for iterative optimization.

It should be noted that the validity of the methods provided in some embodiments of the present disclosure depends on the predictive ability of the machine learning model and the accuracy of the simulation model. In addition, due to the complexity of an actual physical system, there may be some uncertainty factors, such as nonlinear effect and turbulence, and these factors may affect the prediction accuracy of the model. Therefore, in a practical application, it is also necessary to consider a plurality of types of factors comprehensively, including model complexity, computational cost, required prediction accuracy, and the like.

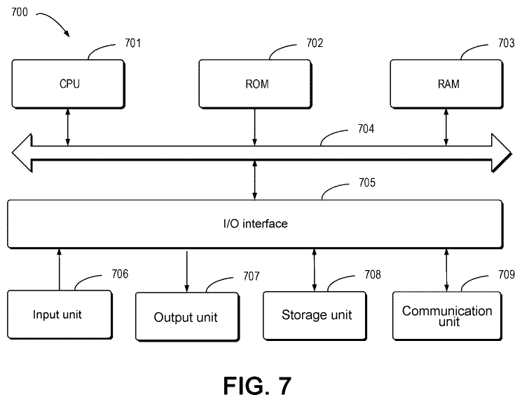

FIG. 7 is a block diagram of an example device 700 which can be used to implement embodiments of the present disclosure. The computing device 106 in FIG. 1, for example, may be implemented using the device 700. As shown in the figure, the device 700 includes a central processing unit (CPU) 701 that may execute various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM703. The CPU 701, the ROM 702, and the RAM 703 are connected to each other through a bus 704. An input/output (I/O) interface 705 is also connected to the bus 704.

A plurality of components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The various processes and processing described above, such as the method 300, may be performed by the CPU 701. For example, in some embodiments, the method 300 may be implemented as a computer software program that is tangibly included in a machine-readable medium such as the storage unit 708. In some embodiments, part or all of the computer program may be loaded and/or installed onto the device 700 via the ROM 702 and/or the communication unit 709. When the computer program is loaded into the RAM 703 and executed by the CPU 701, one or more actions of the method 300 described above may be implemented.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, apparatus (system), and computer program product according to embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means for implementing the functions/acts specified in one or more blocks in the flow charts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various aspects of the functions/acts specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for determining a prediction result, the method comprising:
acquiring a first operating condition data set;
outputting a first output result corresponding to the first operating condition data set through a machine learning model, wherein the machine learning model is obtained by training on a second operating condition data set and a second prediction result, and the second prediction result is obtained by simulating on the second operating condition data set; and
determining a corresponding first prediction result by simulating on the first operating condition data set based on the first output result.

2. The method according to claim 1, further comprising:
using the first operating condition data set, the first prediction result, the second operating condition data set, and the second prediction result as training data, retraining the machine learning model to obtain an updated machine learning model;
outputting a second output result corresponding to a third operating condition data set through the updated machine learning model; and
simulating on the third operating condition data set based on the second output result to obtain a corresponding third prediction result.

3. The method according to claim 2, wherein the first operating condition data set, the second operating condition data set, and the third operating condition data set are obtained by sampling operating condition data, and a network structure of the machine learning model is determined according to a sampling size corresponding to the sampling.

4. The method according to claim 3, further comprising:
determining a prediction result corresponding to the operating condition data by performing interpolation with the first prediction result, the second prediction result, and the third prediction result.

5. The method according to claim 1, wherein the operating condition data set comprises heating related parameters and cooling related parameters, the prediction result and a generation result comprise temperature field data of a server, the heating related parameters refer to parameters that cause the temperature of a chassis of the server to rise, and the cooling related parameters refer to parameters that cause the temperature of the chassis of the server to decrease.

6. The method according to claim 5, wherein the first operating condition data set comprises a first heating related parameter and a first cooling related parameter, and the method further comprises:
establishing a finite element model of the server based on a structure and components of the server; and
determining first temperature field data of the server by applying the first heating related parameter and the first cooling related parameter to the finite element model.

7. The method according to claim 6, wherein determining the first temperature field data of the server comprises:
determining a boundary condition and a mesh generation method for the finite element model; and
determining the first temperature field data of the server by using a simulation algorithm based on the boundary condition and the mesh generation method.

8. The method according to claim 7, wherein determining the boundary condition for the finite element model comprises:
using the first output result as an initial condition and a boundary condition for the finite element model.

9. The method according to claim 1, wherein obtaining the machine learning model by training on the second operating condition data set and the second prediction result comprises:
constructing an initial machine learning model, the initial machine learning model being provided with training parameters;
determining a first result by inputting the second operating condition data set and the second prediction result into the machine learning model; and
adjusting the training parameters iteratively based on a difference between the first result and the second prediction result until the difference meets a preset requirement.

10. An electronic device for determining a prediction result, the electronic device comprising:
at least one processor; and
a memory coupled to the at least one processor and having instructions stored therein, wherein the instructions, when executed by the at least one processor, cause the electronic device to perform actions comprising:
acquiring a first operating condition data set;
outputting a first output result corresponding to the first operating condition data set through a machine learning model, wherein the machine learning model is obtained by training on a second operating condition data set and a second prediction result, and the second prediction result is obtained by simulating on the second operating condition data set; and
determining a corresponding first prediction result by simulating on the first operating condition data set based on the first output result.

11. The electronic device according to claim 10, wherein the actions further comprise:
using the first operating condition data set, the first prediction result, the second operating condition data set, and the second prediction result as training data, retraining the machine learning model to obtain an updated machine learning model;
outputting a second output result corresponding to a third operating condition data set through the updated machine learning model; and
simulating on the third operating condition data set based on the second output result to obtain a corresponding third prediction result.

12. The electronic device according to claim 11, wherein the first operating condition data set, the second operating condition data set, and the third operating condition data set are obtained by sampling operating condition data, and a network structure of the machine learning model is determined according to a sampling size corresponding to the sampling.

13. The electronic device according to claim 12, wherein the actions further comprise:
determining a prediction result corresponding to the operating condition data by performing interpolation with the first prediction result, the second prediction result, and the third prediction result.

14. The electronic device according to claim 10, wherein the operating condition data set comprises heating related parameters and cooling related parameters, the prediction result and a generation result comprise temperature field data of a server, the heating related parameters refer to parameters that cause the temperature of a chassis of the server to rise, and the cooling related parameters refer to parameters that cause the temperature of the chassis of the server to decrease.

15. The electronic device according to claim 14, wherein the first operating condition data set comprises a first heating related parameter and a first cooling related parameter, and the actions further comprise:
establishing a finite element model of the server based on a structure and components of the server; and
determining first temperature field data of the server by applying the first heating related parameter and the first cooling related parameter to the finite element model.

16. The electronic device according to claim 15, wherein determining the first temperature field data of the server comprises:
determining a boundary condition and a mesh generation method for the finite element model; and
determining the first temperature field data of the server by using a simulation algorithm based on the boundary condition and the mesh generation method.

17. The electronic device according to claim 16, wherein determining the boundary condition for the finite element model comprises:
using the first output result as an initial condition and a boundary condition for the finite element model.

18. The electronic device according to claim 10, wherein obtaining the machine learning model by training on the second operating condition data set and the second prediction result comprises:
constructing an initial machine learning model, the initial machine learning model being provided with training parameters;
determining a first result by inputting the second operating condition data set and the second prediction result into the machine learning model; and
adjusting the training parameters iteratively based on a difference between the first result and the second prediction result until the difference meets a preset requirement.

19. A computer program product, the computer program product being tangibly stored on a non-transitory computer-readable medium and comprising machine-executable instructions, wherein the machine-executable instructions, when executed by a machine, cause the machine to perform actions comprising:
acquiring a first operating condition data set;
outputting a first output result corresponding to the first operating condition data set through a machine learning model, wherein the machine learning model is obtained by training on a second operating condition data set and a second prediction result, and the second prediction result is obtained by simulating on the second operating condition data set; and
determining a corresponding first prediction result by simulating on the first operating condition data set based on the first output result.

20. The computer program product according to claim 19, wherein the actions further comprise:
using the first operating condition data set, the first prediction result, the second operating condition data set, and the second prediction result as training data, retraining the machine learning model to obtain an updated machine learning model;
outputting a second output result corresponding to a third operating condition data set through the updated machine learning model; and
simulating on the third operating condition data set based on the second output result to obtain a corresponding third prediction result.
